(19) United States
(12) Patent Application Publication
(10) Pub. No.: US 2008/0143008 A1
(43) Pub. Date: Jun. 19, 2008

(54) MOLDING APPARATUS AND MOLDING PROCESS

(76) Inventors: CHENG-HSIEN KUO, Taipei Hsien (TW); MING-JHY JIANG, Taipei (TW)

Correspondence Address: J.C. Patents, Inc., Suite 250, 4 Venture, Irvine, CA, 92618, US

(21) Appl. No.: 11/562,358

(22) Filed: Nov. 21, 2006

Related U.S. Application Data
(62) Division of application No. 10/871,359, filed on Jun. 18, 2004, now abandoned.
Application No. 10/871,359 is a continuation-in-part of application No. 09/882,040, filed on Jun. 18, 2001, now abandoned.

(30) Foreign Application Priority Data
May 25, 2001 (TW) 90112686

(51) Int. Cl. B29C 45/34

(52) U.S. Cl. 264/101

(57) ABSTRACT

A molding apparatus includes a die set having a chamber, a vacuum pump communicated to the chamber, and a feeding mechanism suited for supplying a molding material to the chamber of the die set with simultaneous extraction of gas out of the chamber by the vacuum pump.

### CROSS-REFERENCE TO RELATED APPLICATION

This application is a continuation-in-part of prior application Ser. No. 09/882,040, filed on Jun. 18, 2001.

### BACKGROUND OF THE INVENTION

1. Field of the Invention

The present invention relates to a molding apparatus and a molding process, and more particularly, to a molding apparatus having a feeding mechanism suited for supplying a molding material to a chamber of a die set with simultaneous extraction of gas out of the chamber, and a corresponding molding process.

2. Description of Related Art

In conventional manufacturing process for plastic injection molding, plastic granules is melted into a polymer fluid. Upon clamping an injection mold, the polymer fluid is injected into the mold under a high pressure. Upon cooling and parting mold, a plastic cast is formed.

A conventional R.O.C. patent application No. 82103905, entitled “INJECTION MOLDING APPARATUS AND INJECTION MOLDING MOLD”, discloses a mold having a first die and a second die. Upon clamping the first and second dies, a reciprocating ejector can push a molding material into a cavity of the mold.

A molded article with large thickness (more than about 1.5 mm) can be shaped by the conventional injection molding under high pressure. However, it is difficult to form an article with very small thickness by the conventional injection molding. The very thin article is subjected to breakage or stress induced distortion due to being molded under a high pressure. Nowadays, various products, such as semiconductor memory card including MS, MS DUO, Mini-SD, SD, xD and SM card, are developed in trends towards lightness, compactness and smallness. A semiconductor memory card has a housing with a very thin portion, which has a thickness less than 0.15 mm and of 0.12 mm at thinnest, for example, and thereby the housing can not be formed by the traditional injection molding.

### SUMMARY OF THE INVENTION

Accordingly, one object of the present invention is to provide a molding apparatus and a molding process for forming an article with a very thin portion. The very thin portion is molded without stress induced distortion or breakage. The present invention overcomes the problem in the prior art by supplying a molding material to a chamber of a die set with simultaneous extraction of gas out of the chamber.

In one embodiment, a molding material is supplied to the chamber by a pushing rod of a feeding mechanism, wherein the pushing rod can be reciprocated to control the pressure in the chamber.

In accordance with one embodiment of the present invention, the chamber has a thinnest space provided with an outlet, through which the chamber is communicated to a vacuum pump. The thinnest space of the chamber has a height ranging from 0.05 mm to 0.5 mm, for example.

In one embodiment, the chamber has an outlet, through which the chamber is communicated to a vacuum pump, and the outlet is formed from multiple slots, each of which has a transverse dimension small enough to prevent the molding material from flowing therethrough. More specifically, the longitudinal distance between a connection port of a sprue and the slot closest to the connection port of the sprue ranges from one-fourth to three-fourth of the longitudinal dimension of the chamber, for example.

In summary, a molding material is supplied to a chamber of a die set with simultaneous extraction of gas out of the chamber, thereby alleviating the creation of back pressure under high speed injecting impulsion. Therefore, uniform distribution of the injected molding material flowing in the chamber can be produced and the residual stress created on the molded article can be lowered.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 is a schematic cross-sectional view showing an injection molding apparatus according to an embodiment of the present invention.

FIG. 2 is a schematic top view showing a chamber of a die set according to an embodiment of the present invention.

### DESCRIPTION OF THE ILLUSTRATED EMBODIMENTS

The simplest embodiment of the present invention would be to supply a molding material to a chamber of a die set with simultaneous extraction of gas out of the chamber. Alternatively or in addition, the gas may be extracted by a vacuum pump when the molding material is injected into the chamber of the die set.

Various specific embodiments of the present invention are disclosed below, illustrating examples of various possible implementations of the concepts of the present invention. The following description is made for the purpose of illustrating the general principles of the invention and should not be taken in a limiting sense. The scope of the invention is best determined by reference to the appended claims.

### The Embodiment

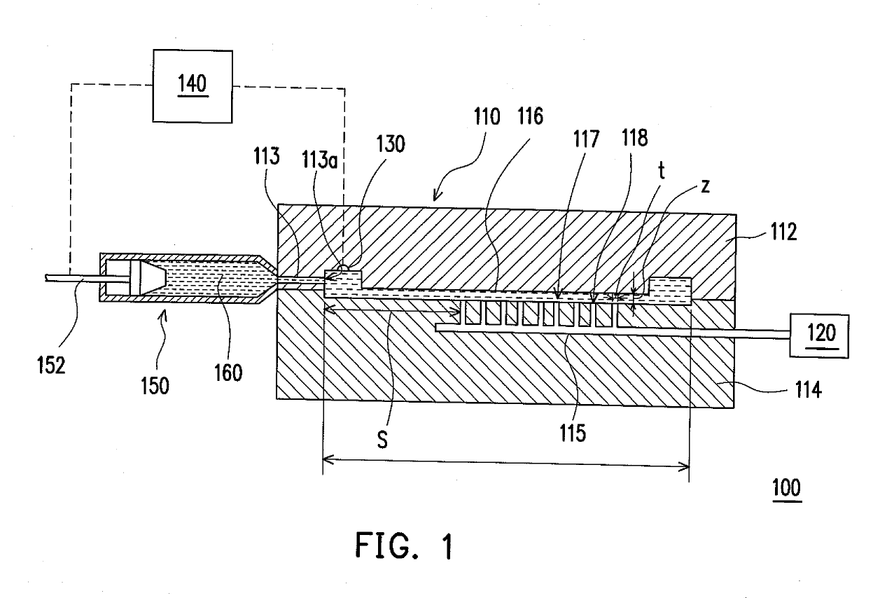

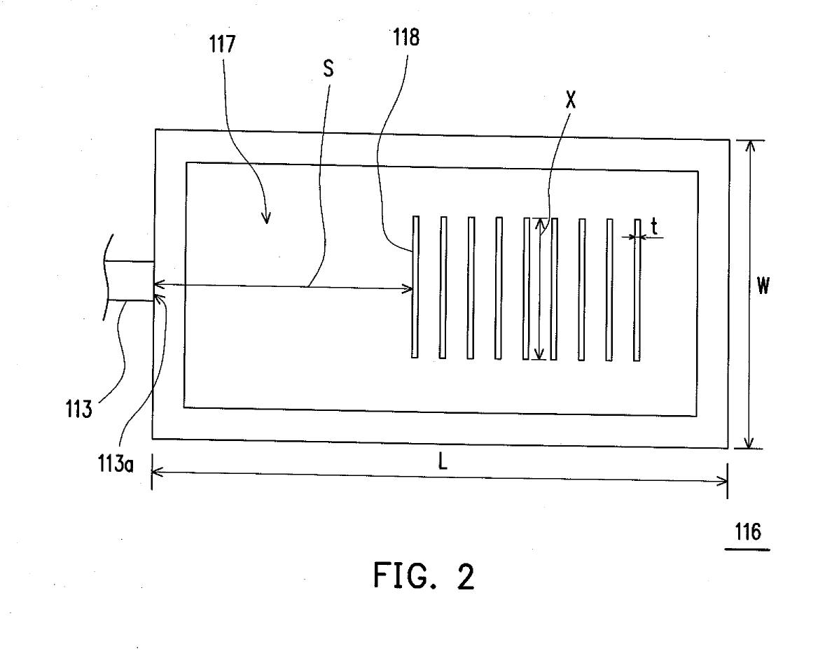

FIG. 1 is a schematic cross-sectional view showing an injection molding apparatus according to an embodiment of the present invention. FIG. 2 is a schematic top view showing a chamber of a die set according to an embodiment of the present invention. Referring to both FIG. 1 and FIG. 2, the injection molding apparatus 100 includes a die set 110, a vacuum bump 120, a pressure detecting device 130, a digital control device 140 and a feeding mechanism 150.

The die set 110 includes two dies 112 and 114 that are automatically clamped and form a chamber 116 therebetween. For forming a molded article, such as a housing of a semiconductor memory card including MS, MS DUO, Mini-SD, SD, xD and SM card, the feeding mechanism 150 injects a molding material 160, such as polymer, into the chamber 116 through a sprue 113 in the die 112 by moving a pushing rod 152, for example, wherein the pushing rod 152 can be reciprocated to control the pressure in the chamber 116.

The die 114 is bored an air vent 115 communicating the chamber 116 to the vacuum bump 120. When the molding material 160 is being injected into the chamber 116 by the feeding mechanism 150, air is being simultaneously extracted out of the chamber 116 by the vacuum bump 120. Therefore, the creation of back pressure under high speed injecting impulsion can be alleviated. Uniform distribution of the injected molding material 160 flowing in the chamber 116 can be produced and the residual stress created on the molded article can be lowered.

The chamber 116 has a thinnest space 117 having a thickness z ranging from 0.05 mm to 0.5 mm, for example. The thinnest space 117 is provided with an outlet 118, through which the chamber 116 is communicated to the vacuum pump 120. The outlet 118 may be formed from multiple slots, each of which has a transverse dimension t small enough to prevent the molding material 160 from flowing therethrough.

The sprue 113 has a connection port 113a connected with the chamber 116. The chamber 116 has a longitudinal dimension L, the longitudinal distance S between the slot 118 closest to the connection port 113a of the sprue 113 and the connection port 113a of the sprue 113 ranges from one-fourth to three-fourth of the longitudinal dimension L of the chamber 116, for example. The chamber 116 has a lateral dimension w and one of the slots 118 has a longitudinal dimension x ranging from one-third to five-sixth of the lateral dimension w of the chamber 116, for example.

The pressure detecting device 130 connected to the chamber 116 is provided to detect the pressure in the chamber 116. The digital control device 140 manipulates the reciprocation of the pushing rod 152 of the feeding mechanism 150 to control the pressure in the chamber 116. When the pressure in the chamber 116 detected by the pressure detecting device 130 exceeds a predetermined pressure value, the pushing rod 152 immediately retracts back upon the manipulation of the digital control device 140, thereby the molding material being extracted and the pressure in the chamber 116 coming down to the predetermined pressure value. Therefore, during the molding material being injected into the chamber 116, the pressure in the chamber 116 can be always kept at the predetermined pressure value. The molding material can be fast flowed into the thinnest space 117 in a uniform-speed distribution with time and thus the residual stress created on the molded article can be lowered. The phenomenon of the stress induced distortion created on the molded article can be resolved.

In the molding method, the amount of the molding material injected into the chamber 116 can be preset under precise calculation. After the amount of the molding material is injected into the chamber 116, fine adjustment of feeding or extracting molding material into or from the chamber 116 by the digital control device 140 manipulating the reciprocation of the pushing rod 152 of the feeding mechanism 150 is performed until the pressure in the chamber 116 attains to a predetermined pressure value.

### CONCLUSION

The molding apparatus includes a feeding mechanism suited for supplying a molding material into a chamber of a die set with simultaneous extraction of gas out of the chamber, thereby alleviating the creation of back pressure under high speed injecting impulsion. Moreover, the pressure in the chamber is kept at a predetermined pressure when the molding material is injected into a chamber. Therefore, uniform distribution of the injected molding material flowing in the chamber can be produced and the residual stress created on the molded article can be lowered.

Although the invention has been described with reference to a particular embodiment thereof it will be apparent to one of ordinary skill in the art that modifications to the described embodiment may be made without departing from the spirit of the invention. Accordingly, the scope of the invention will be defined by the attached claims not by the above detailed description.

1-14. (canceled)

15. A molding process comprising:
clampling a die set; and
supplying a molding material to a chamber of said die set with simultaneous extraction of gas out of said chamber.
